(19) United States
(12) Patent Application Publication
(10) Pub. No.: US 2010/0269295 A1
(43) Pub. Date: Oct. 28, 2010

(54) HINGE

(75) Inventor: WEN-BIN SHEN, Tu-Cheng (TW)

Correspondence Address: Altis Law Group, Inc.;ATTN: Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/483,259

(22) Filed: Jun. 12, 2009

(30) Foreign Application Priority Data
Apr. 28, 2009 (CN) 200920302661.4

(51) Int. Cl. E05D 11/10

(52) U.S. Cl. 16/333; 16/344

(57) ABSTRACT

A hinge includes a first connecting member, a shaft fixed to the first connecting member, a second connecting member rotatably mounted to the shaft, a positioning member fixed to the second connecting member, a first stopping member, a second stopping member and a fastener fixed to the shaft. A first raised portion extends from a first side of the second connecting member. The first and second stopping members each having a resisting surface are fixed to the shaft, and the first stopping member is sandwiched between the first side of the second connecting member and the positioning member. A withstanding protrusion protrudes out from the positioning member. When the second connecting member is rotated relative to the first connecting member to a predetermined degree, the resisting surfaces of the first and second stopping members resist against the first raised portion and the withstanding protrusion.

### BACKGROUND

1. Technical Field

The disclosure relates to a hinge.

2. Description of Related Art

A collapsible device, such as a notebook computer, or a clamshell mobile phone, generally including a main body and a cover often uses a hinge to interconnect the main body and the cover. The hinge allows the cover to be rotatable with respect to the main body, and to be folded with the main body for saving space.

A hinge normally includes a first element and a second element fixed to the main body and the cover of the collapsible device, respectively. The first and second elements are rotatable relative to and in friction engagement with each other for maintaining the cover at any angle with respect to the main body. During rotation, the cover can maintain at any angle with respect to the main body by friction between the first and second elements. However, the first and second elements are not durable after frequent usage and due to wear and tear, resulting in preventing the cover from being able to stay at certain desirable positions. When one of the first and second elements is worn out, the cover cannot maintain stability at certain desirable positions with respect to the main body, which creates a quite inconvenience for users. Even worse, the cover can be over-rotated by enough force resulting in damaging the hinge.

### BRIEF DESCRIPTION OF THE DRAWINGS

FIG. 1 is an exploded, isometric view of an exemplary embodiment of a hinge, the hinge including a first connecting member and a second connecting member.

FIG. 2 is an inverted view of the hinge of FIG. 1.

FIG. 3 is an assembled, isometric view of the hinge of FIG. 1.

FIG. 4 is similar to FIG. 3, but viewed from another perspective, and showing the second connecting member being rotated an angle relative to the first connecting member.

FIG. 5 is similar to FIG. 4, but viewed from another perspective.

### DETAILED DESCRIPTION

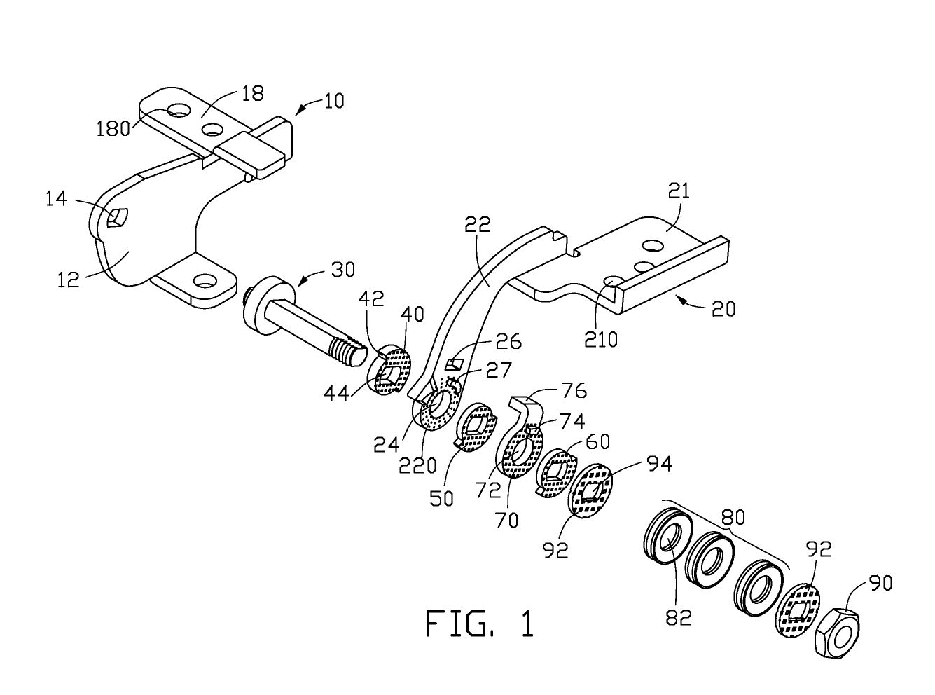

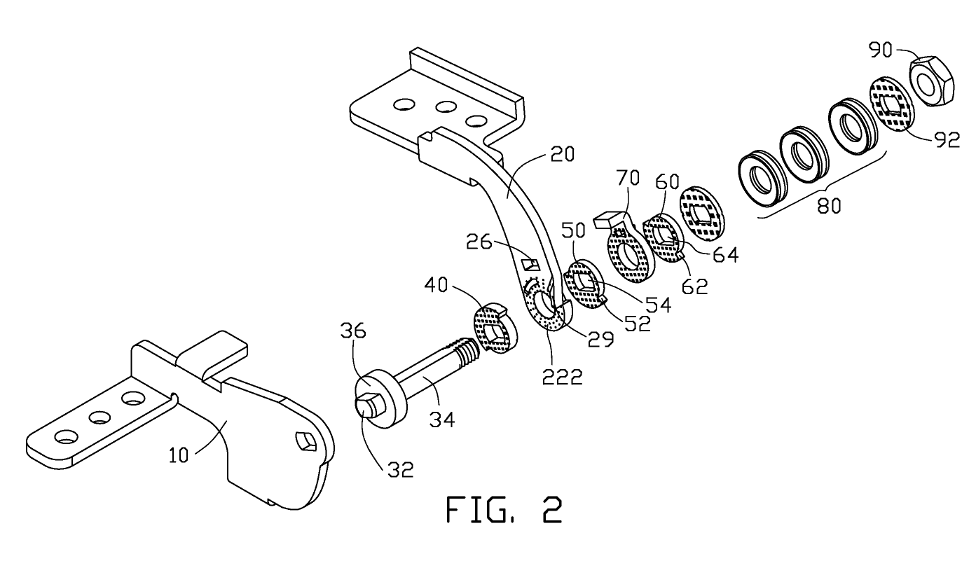

Referring to FIGS. 1 and 2, an exemplary embodiment of a hinge includes a first connecting member 10, a second connecting member 20, a shaft 30, a first stopping member 50, a second stopping member 60, a third stopping member 40, a positioning member 70, two friction members 92, a plurality of elastic rings 80 sandwiched between the friction members 92, and a fastener 90. In the embodiment, the fastener 90 is a nut.

The shaft 30 includes a fixing portion 32, a shaft body 34, and a resisting portion 36 between the fixing portion 32 and the shaft body 34. The fixing portion 32 has a double-D shaped cross-section for fixing to the first connecting member 10. The shaft body 34 has a double-D shaped cross-section, and forms a threaded portion (not labeled) on a circumference of a distal end of the shaft body 34, for engaging with the fastener 90.

The first connecting member 10 includes a connecting portion 18 defining a plurality of fixing holes 180, and a fixing board 12 extending from an end of the connecting portion 18 and perpendicularly to the fixing board 12. The fixing board 12 defines a fixing hole 14 having a double-D shape, corresponding to the fixing portion 32 of the shaft 30, for fixing the shaft 30 to the first connecting member 10.

The second connecting member 20 includes a fixing body 21 defining a plurality of fixing holes 210, and a curved pivoting portion 22 extending from an end of the fixing body 21. The pivoting portion 22 includes a first side 220 and a second side 222 opposite to the first side 220. The pivoting portion 22 defines a through hole 24 passing through the first and second sides 220, 222 for allowing the shaft body 34 to rotatably pass therethrough. A wedge-shaped first raised portion 27 protrudes out from the first side 220, and one end of the first raised portion 27 smoothly slants to connect to the first side 220. A matching hole 26 is defined in the pivoting portion 22, neighboring to the first raised portion 27. A wedge-shaped second raised portion 29 protrudes out from the second side 222, along an edge of the pivoting portion 22 and neighboring to the through hole 24. One end of the second raised portion 29 smoothly slants to connect to the second side 222.

The first, second, and third stopping members 50, 60, 40 are similar to one another, and all of them are generally washer-shaped. Each of the first, second, and third stopping members 50, 60, 40 defines an arcuate cutout (not labeled) along a circumference thereof, and each of opposite ends of each cutout forms a resisting surface 52, 62, 42. Each of the first, second, and third stopping members 50, 60, 40 defines a shaft hole 54, 64, 44 in a center thereof, having a double-D shape, corresponding to the shaft body 34 of the shaft 30, for unrotatably fitting about the shaft body 34 of the shaft 30.

The positioning member 70 defines a round hole 72 therein, for allowing the shaft body 34 of the shaft 30 to rotatably pass therethrough. A fixing post 76 axially extends from a first side of the positioning member 70, facing the first stopping member 50. A withstanding protrusion 74 protrudes from a second side opposite to the first side of the positioning member 70.

Each elastic ring 80 provides elasticity along an axial direction of the shaft 30, to tighten the first connecting member 10, the second connecting member 20, all the stopping members 40, 50, 60, the positioning member 70, and one of the friction members 92. Each elastic ring 80 defines a round through hole 82, allowing the shaft body 34 of the shaft 30 to rotatably pass therethrough.

Each friction member 92 defines a double-D shaped fixing hole 94, for unrotatably receiving the shaft body 34 of the shaft 30.

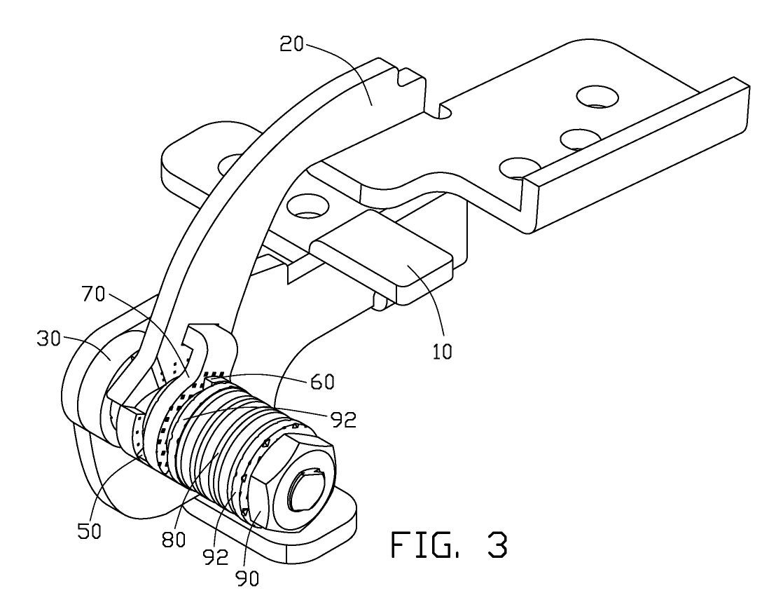

Referring to FIG. 3, in assembly, the fixing portion 32 of the shaft 30 is fixedly received in the fixing hole 14 of the first connecting member 10, therefore, the shaft 30 is fixed to the first connecting member 10. The shaft body 34 of the shaft 30 is passed through the shaft hole 44 of the third stopping member 40, the through hole 24 of the second connecting member 20, the shaft hole 54 of the first stopping member 50, the round hole 72 of the positioning member 70, the shaft hole 64 of the second stopping member 60, the fixing hole 94 of one of the friction members 92, the through holes 82 of the plurality of elastic rings 80, and the fixing hole 94 of the other friction member 92 one by one in that order, with the distal end of the shaft body 34 engaging in the fastener 90 for preventing the second connecting member 20, the stopping members 50, 60, 40, the positioning member 70, the friction members 92, and the plurality of elastic rings 80 from disengaging from the shaft 30.

In the aforementioned assembly, the fixing post 76 of the positioning member 70 is fixed to the matching hole 26 of the second connecting member 20, therefore, the positioning member 70 is rotated with the second connecting member 20. The first and second raised portions 27, 29 of the second connecting member 20 are received in the cutouts of the first and third stopping members 50, 40, respectively. The withstanding protrusion 74 is received in the cutout of the second stopping member 60.

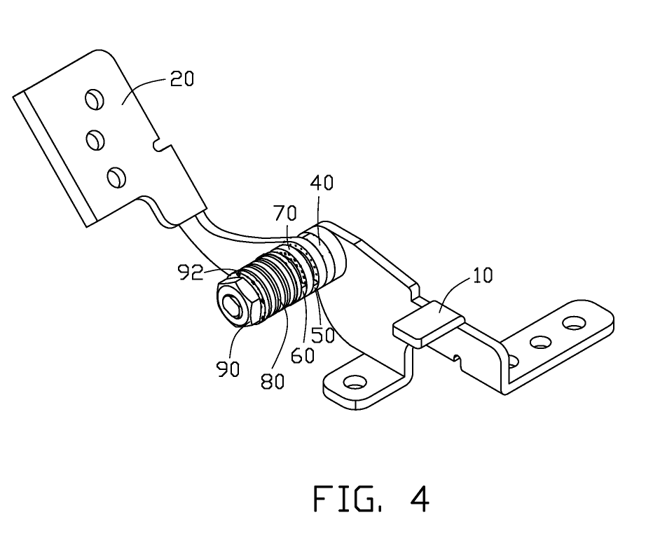

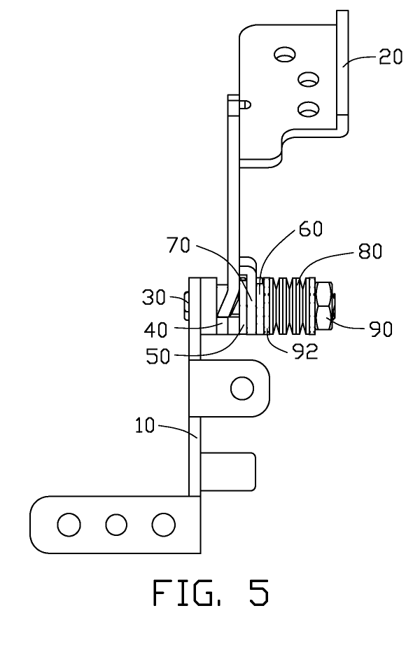

Referring to FIGS. 4 and 5, in use, the first connecting member 10 is fixed to one of a cover and a base of a collapsible device (not shown), via the plurality of fixing holes 180, and the second connecting member 20 is fixed to the other one of the cover and the base of the collapsible device, via the plurality of fixing holes 210. Therefore, during rotation of the cover relative to the base, the second connecting member 20 rotates relative to the first connecting member 10, together with the positioning member 70. When the second connecting member 20 is rotated to a predetermined degree relative to the first connecting member 10, the first and second raised portions 27, 29 of the second connecting member 20 resist against the corresponding resisting surfaces 52, 42 of the first and third stopping members 50, 40, respectively, together with the withstanding protrusion 74 of the positioning member 70 resisting against one of the resisting surfaces 62 of the second stopping member 60. Therefore, the second connecting member 20 cannot be rotated further relative to the first connecting member 10. As a result, the cover is stably maintained at the predetermined degree with respect to the base resulting preventing the cover from over-rotating.

It is believed that the present embodiment and its advantages will be understood from the foregoing description, and it will be apparent that various changes may be made thereto without departing from the spirit and scope of the description or sacrificing all of its material advantages, the example hereinbefore described merely being exemplary embodiment.

What is claimed is:

1 A hinge comprising:
a first connecting member;
a shaft fixed to the first connecting member, and comprising a shaft body;
a second connecting member rotatably mounted to the shaft body, a first raised portion protruding out from a first side of the second connecting member;
a positioning member fixed to the second connecting member, facing the first side of the second connecting member, and rotatably mounted to the shaft body, the positioning member comprising a withstanding protrusion extending from the positioning member away from the second connecting member;
a first stopping member and a second stopping member both fixed to the shaft body, each of the first and second stopping member comprising a resisting surface, wherein the first stopping member is located between the first side of the second connecting member and the positioning member; and
a fastener fixed to a distal end of the shaft body, to prevent the second connecting member, the positioning member, the first and second stopping members from disengaging from the shaft body;
wherein during rotation of the second connecting member relative to the first connecting member to a predetermined degree, the first raised portion of the second connecting member resists against the resisting surface of the first stopping member, and simultaneously, the withstanding protrusion of the positioning member resists against the resisting surface of the second stopping member.

2. The hinge of claim 1, wherein the second connecting member defines a matching hole, a fixing post extends from the positioning member, opposite to the withstanding protrusion, for being fixedly received in the matching hole.

3. The hinge of claim 1, further comprising a third stopping member fixed to the shaft body, wherein the third stopping member comprises a resisting surface, a second raised portion protrudes out from a second side opposite to the first side of the second connecting member, to resist against the resisting surface of the third stopping member.

4. The hinge of claim 3, wherein the shaft further comprises a resisting portion, and the shaft body extends from the resisting portion, opposite sides of the third stopping member resist against the resisting portion and the second connecting member, respectively.

5. The hinge of claim 4, wherein the shaft still further comprises a fixing portion extending from the resisting portion opposite to the shaft body, the first connecting member defines a fixing hole, the fixing portion of the shaft is fixed in the fixing hole.

6. The hinge of claim 3, wherein the first and second raised portion are wedge-shaped, and each of the first and second raised portions comprises an end smoothly slanting to connect to a corresponding one of the first and second side of the second connecting member.

7. A hinge comprising:
a first connecting member;
a shaft fixed to the first connecting member, and comprising a shaft body;
a second connecting member rotatably mounted to the shaft body, a first raised portion and a second raised portion extending from opposite sides of the second connecting member;
a first stopping member and a second stopping member both fixed to the shaft body, each of the first and second stopping member comprising a resisting surface, wherein the second connecting member is sandwiched between the first and second stopping members;
at least one elastic ring rotatably mounted to the shaft body; and
a fastener fixed to a distal end of the shaft body to prevent the second connecting member, the at least one elastic ring, the first and second stopping members from disengaging from the shaft body;
Wherein during rotation of the second connecting member relative to the first connecting member to a predetermined degree, the first and second raised portions resist against the resisting surfaces of the first and second stopping members, respectively.

8. The hinge of claim 7, further comprising a positioning member fixed to the second connecting member, and abutting about the first stopping member, wherein the positioning member defines a round hole to allow the shaft body rotatably to pass therethrough.

9. The hinge of claim 8, further comprising a third stopping member fixed to the shaft body and abutting against the positioning member opposite to the first stopping member, wherein the third stopping member comprises a resisting surface, a withstanding protrusion protrudes out from the positioning member to resist against the resisting surface of the third stopping member.

10. The hinge of claim 8, wherein the second connecting member defines a matching hole, a fixing post extends from the positioning member to engage in the matching hole.

11. The hinge of claim 8, further comprising two friction members fixed to the shaft body, beside opposite sides of the at least one elastic ring, wherein one of the friction members abuts against the third stopping member, and the other friction member resists against the fastener.

12. The hinge of claim 7, wherein the shaft further comprises a resisting portion, the shaft body extends from the resisting portion, and opposite sides of the second stopping member resist against the resisting portion and the second connecting member, respectively.
